(19) United States
(12) Patent Application Publication
(10) Pub. No.: US 2009/0285944 A1
(43) Pub. Date: Nov. 19, 2009

(54) Food Composition

(76) Inventors: Jean-Luc Rabault, Ponthevrard (FR); Francois Belouin, Cerny (FR)

Correspondence Address: FITCH EVEN TABIN & FLANNERY, 120 SOUTH LASALLE STREET, SUITE 1600, CHICAGO, IL, 60603-3406, US

(21) Appl. No.: 12/440,890

(22) PCT Filed: Sep. 6, 2007
(86) PCT No.: PCT/FR07/51884

§ 371 Date: Mar. 11, 2009

(30) Foreign Application Priority Data
Sep. 11, 2006 (FR) 06 07937

(51) Int. Cl. A23G 3/54; A21D 10/00; A21D 13/00; A23G 3/42; B65D 69/00

(52) U.S. Cl. 426/94; 426/549; 426/103; 206/223

(57) ABSTRACT

The invention relates to a food composition consisting of a continuous aqueous phase, wherein said food composition has a water activity (Aw) of 0.3 to 0.99 and a fat content of less than 15% by weight relative to the total weight of the food composition, and comprises at least one non-gelatinized starch.

This invention relates to a food composition consisting of a continuous aqueous phase, wherein said food composition has a water activity (Aw) of 0.3 to 0.99 and a fat content of less than 15% by weight relative to the total weight of the composition, and comprises at least one non-gelatinized starch.

The reduction in fat content (MG) and sugars in food products, while keeping their organoleptic properties and their texture, is a major challenge for the agroalimentary industry. Such reduction in sugar content, sucrose in particular, is very desirable in fighting obesity, notably in the domain of products with high sugar content.

Jams, jellies, or fruits pastes are prepared from natural fruits and/or fruit juices, as well as from a large quantity of sugars such as sucrose and glucose syrup in most cases. Generally, citric acid and/or pectin are also added. Using modified gelatinized starches is also known in some filling or topping jams, or in some fruit preparations, in order to improve cooking resistance.

Traditional jams generally have a sugar content of 60 to 68% by weight. Also known are light jams in which all or part of the sugars is replaced by water. But their conservation is more delicate and they should thus be kept in a refrigerator after being opened. Moreover, they always contain 42 to 46% of sugars, and almost always nearly 100% of the calories are contributed by sugars.

Honey contains 76 to 78% of sugars, and there are no sugar light honeys.

Today, consumers are increasingly preoccupied by nutrition and potential benefits of food, and more and more consumers are in search of products light in sugars and/or fat which, at the same time, procure a prolonged feeling of repletion. Thus, adding soluble and insoluble fibers has also been proposed. However, these solutions present many inconveniences. It is true that soluble fibers increase repletion, but their use is often linked to digestive disorders such as bloating, flatulences, or accelerated transit. Insoluble fibers cause intestinal irritations in general, and are not always acceptable at the organoleptic level.

It is known to add gelatinized starch, either by using a pre-gelatinized starch, or most often, by cooking a native starch during the manufacturing process, as a jam thickener (texture agent) notably during pasteurization or sterilization.

Moreover, said gelatinized native starch undergoes a retrogression over time, especially for very low humidity products, which results in a texture modification, namely syneresis. To avoid this phenomenon, starch is sometimes modified chemically or physically.

However, the modification greatly reduces the benefits of starch for the consumer, because such starch is now perceived as an additive, not as a natural ingredient.

In addition, cooking, under the effect of hydration and heat, has the effect of increasing a food glycemic index. Carrots, for example, have a glycemic index of 35 when raw. As soon as boiled in water their glycemic index increases to 85 because of its starch gelatinization. A food rich in nutrients with high glycemic index is namely not in line with nutritionists' recommendations for food with low glycemic index.

One goal of this invention is therefore to palliate to all or part of the above stated inconveniences and notably to propose food compositions more in line with the nutritionists' recommendations to reduce calories originating from fat or sugars, and to increase the caloric part coming from complex carbohydrates.

Another goal is to propose food compositions with a higher and/or more prolonged satiating power than food compositions of the anterior art.

To this end, this invention proposes a food composition consisting of a continuous aqueous phase, with a water activity (Aw) of 0.3 to 0.99 and a fat content less than 15% by weight relative to the total weight of the food composition, and comprising at least one non-gelatinized starch.

The man of the art knows different techniques to recognize non-gelatinized starch; the simplest being the observation under a polarized light microscope: Non-gelatinized grains appear shaped as a “Maltese cross” (birefringence), whereas gelatinized grains lose this characteristic.

The continuous aqueous phase food compositions according to this invention include notably jams, honeys, jellies, continuous aqueous phase spread products, compotes, fruit and/or vegetable mashes with or without chunks, fruit desserts, fruit pastes. The term “continuous aqueous phase spread products” according to this invention designates a food commodity that, from its consistency, is suitable to be spread on bread or other similar uses, but which composition doesn't meet the definition of jelly or jam. “Continuous aqueous phase spread products” can be obtained e.g. from fruit mash, concentrated fruits juices, or nut paste.

The water activity (Aw) of a material is defined as the ratio between the material water vapor pressure and pure water vapor pressure at the same temperature. This notion is well known of the skilled man who knows perfectly the appropriate measuring methods. In most cases, water activity is not proportional to the water content of the material. Thus, water activity (Aw) of a fruit yogurt with 82% water content by weight is for example 0.99, while butter, which also has a 0.99 water activity, has 16% water content by weight. As a convention, we measure all Aw in this invention at 25° C., and 24 hours to 3 days after manufacturing the recipes.

Food composition water activity (Aw) according to the invention is generally from 0.3 to 0.99, preferably from 0.4 to 0.99, and more preferentially from 0.50 to 0.90, from 0.58 to 0.82, and from 0.58 to 0.73. If Aw is from 0.3 to 0.6, the composition is preserved at a temperature from 15 to 25° C. for at least one month, preferably for at least 6 months. If Aw is from 0.6 to 0.8, the composition is preserved at a temperature from 15 to 25° C. for at least one week, preferably for at least 1 month. If Aw is from 0.8 to 0.99, the composition is preserved at a temperature ranging from 1 to 10° C. for at least one week, preferably for at least 1 month, or in a frozen storage for at least 1 month, preferably for at least 6 months.

Advantageously, dry matter content of food compositions according to the invention is less than 80%, preferably less than 70%, and more preferentially even less than 60% by weight.

The applicant had had the merit to find that it was possible to improve the nutritional composition and to increase the satiating power of food compositions, notably for jams and honeys, and to improve their nutritional composition in accordance with the nutritionists' recommendation, by adding at least one non-gelatinized starch. In fact, by adding non-gelatinized starch, one increases the ratio (calories brought by slowly digestible carbohydrates)/(total calorie content), which delays the occurrence of hungry feeling after consuming a food composition according to the invention.

The addition of non-gelatinized starch not only does increase the ratio (calories brought by slowly digestible carbohydrates)/(total calorie content), but also reduce the food composition content in sugar, notably sucrose, and/or fat. According to this invention, it is thus possible to provide food compositions light in sugars, notably in sucrose, that possesses a satiating power higher than traditional light food composition having the same sugar content, notably in sucrose.

According to this invention, it is thus possible to provide food compositions light in fat and/or sugars, which possess a satiating power higher than a traditional light food composition.

The food compositions according to the invention have a fat content of less than 15% by weight in relation to the total weight of the food composition. Preferably, fat content is from 0 to 10%, preferably from 0 to 5%, and more preferentially from 0 to 3, and even from 0 to 1% by weight in relation to the total weight of the food composition.

Contrary to sugars, non-gelatinized starch is not sweet and is not water soluble, it is therefore surprising that food compositions according to the invention present similar, or even better, organoleptic characteristics than very sugary conventional products, often perceived as burning the mouth or the back throat.

According to the invention, any type of starch can be used in the food composition provided it is a non-gelatinized starch. The term “non-gelatinized starch” means that the starch is neither pre-gelatinized, nor gelatinized during the process of manufacture or preparation before consumption. Of course, one may use mixtures of starches of different origins.

The starches that can be used to the ends of this invention include wheat starch, rice starch, corn starch, waxy corn starch, sorghum starch, tapioca starch, potato starch, cassava starch, and their mixtures.

Advantageously, the non-gelatinized starch is a native starch. Contrary to the gelatinized starches and to most other hydrocolloids, including proteins and maltodextrines, native starch presents a low water absorption in general. Therefore, adding native starch to a food composition constituted of a continuous aqueous phase causing only a light increase in viscosity, while gelatinized starch or other aforementioned hydrocolloids will cause an important increase in viscosity. The use of native starch enables thus to add more important quantities of starch in relation to the gelatinized starch, while keeping a viscosity close to that of the starting product.

Moreover, native starch being a non-modified natural product, it is not part of the food additives, which should be labeled as such on the package of the marketed product.

In addition, native starch does not present any digestive inconveniences, contrary to polyols, and soluble fibers that have, among others, a laxative effect, which is particularly undesirable in products intended for children. The fact that it is non-gelatinized keeps the native starch slowly digestible, which enables to increase the (calories brought by slowly digestible carbohydrates)/(total calorie content) ratio. So, the addition of native starch to food compositions according to the invention entails a prolonged repletion sensation in relation to food compositions constituted of a traditional continuous aqueous phase, notably in relation to food compositions constituted of a continuous aqueous phase light in sugars and/or in fat. And especially, the calorie distribution is more balanced between complex carbohydrates, fat, and sugars, in accordance with nutritionists' recommendations.

In addition, native starch density is high, which limits steric congestion, and its granules present little porosity accessible to water constituting the continuous aqueous phase. These two characteristics are important in order to limit the increase in viscosity of food composition containing solids in suspension such as starch granules.

The particle-size distribution of native starches, which generally ranges between 2 μm and 100 μm, and generally between 5 μm and 45 μm, is also ideal for a use in food compositions constituted of a continuous aqueous phase. Thus, native starches include neither too many fine particles, nor too many large particles. The presence of fine particles increases the viscosity of the food composition, and requires therefore to increase fat and/or water content in general. However, in a large number of food compositions, e.g. jams or honeys, it is not possible to increase water and/or fat content without considerably altering their organoleptic and/or preservation properties. On the contrary, the presence of large particles confers a sandy sensation in the mouth to food composition. The balance between small, and large size granules may be adjusted as needed according to sought-after textures and properties, by mixing starches of various origins in various proportions.

In an advantageous mode embodiment, at least 90% of the starch particle-size ranges between 2 μm and 100 μm, preferably between 5 μm and 45 μm.

In another form of embodiment, at least 5%, preferably at least 10%, and more even preferentially at least 15% of the starch particles have a size greater than or equal to 10 μm. In this way, one obtains a good compromise between the viscosity increase of the food composition following the addition of non-gelatinized starch, and the increase of the ratio (calories brought by carbohydrate complexes)/(total calorie).

Of course, it is also possible to use one or several starches with at least 90% of starch particle size ranging between 2 μm and 100 μm, preferably between 5 μm and 45 μm, and with at least 5%, preferably at least 10%, and more preferentially even at least 15% starch particle size greater than or equal to 10 μm.

Among the native starches, one prefers wheat starch, because it presents an ideal particle-size distribution from 2 μm to 45 μm, and because it is cheap.

Corn and cassava starches are also among the preferred starches for their particle-size distribution.

Other advantages of native starch are its neutral flavor and its white color, which enables its use in a broad product line, such as jams, honeys, and compotes. Finally, native starch is a cheap ingredient; and it can be used without grinding in food compositions constituted of a continuous aqueous phase, which helps simplify the manufacturing process and a greater productivity.

However, it is also possible to use ground starch in order to obtain specific particle-size distributions that are not, or hardly, accessible without grinding.

In addition to native starch, one can also use overdry starches according to the invention, e.g. non-gelatinized starches with a humidity content brought below their relative humidity at equilibrium. One may also consider using a mixture of native, and overdry starches, or different types of overdry starches.

A non-gelatinized starch is generally contributed under form of a starch powder, but can also be contributed in all or in part as flour rich in non-gelatinized starch, or as a flour mixture rich in starch. The use of starch powder is preferred, even if in some cases using a flour rich in starch can be advantageous, notably in terms of cost.

A starch powder is preferred namely because it modifies less than flour the characteristics of the product into which it is incorporated. Thus, starch powder makes the product that contains it less sticky than flour from the absence of proteins. In addition, starch powder presents a finer particle-size distribution than flour because it mainly contains isolated starch grains, and no grinded cells as flour. Finally, starch powder has a more neutral taste, and a whiter color than flour.

A flour rich in starch can be a native or overdry flour. One can use cereal flours for example, such as wheat flour, corn flour, or rice flour, or tuber flours, such as potato flour. As an example, one can mention wheat flour, which can be assimilated to a mixture by weight of 12% proteins, 83% starch with 13% water, 1% fat, and 4% fibers.

In one form of embodiment, the starch content of the food composition according to the invention is from 2 to 40%, preferably from 4 to 40%, and even more preferentially from 10 to 40%, advantageously from 20 to 40%, and even from 30 to 40% by dry weight in relation to the weight of the food composition. Wheat starch generally contains 13% of water, and 87% of dry starch. Using 40% of wheat starch therefore contributes 34.8% of dry starch.

For a compote, a fruit mash, or compositions having a greater than or equal to 0.93 Aw, the starch content advantageously ranges between 2 and 20%, preferably between 5 and 15%, and even more preferentially between 5 and 10% by dry weight in relation to the weight of the food composition.

Starch grains forming a suspension in the aqueous phase of the food composition, the skilled man will preferably choose therefore a low flow threshold for the food composition according to the invention, in order to avoid or limit the starch grain sedimentation. In some cases, however, the starch grain sedimentation can be acceptable, or even sought-after.

The food composition according to the invention can be a sweet or salty flavor composition.

Food compositions according to the invention have a sugar content from 0 to 84%, preferably from 0 to 56%, and even more preferentially from 0 to 48%, from 10 to 48% and even from 10 to 36% by weight in relation to the total weight of the food composition. In the case of salty flavor food compositions according to the invention, the sugar content is generally from 0% to 55%, preferably from 0 to 35%, and even more preferentially from 0 to 25%, and even from 5 to 25%, and more particularly from 5 to 15% by weight in relation to the total weight of the food composition. Sugary flavor food compositions according to the invention include preferably from 0 to 84%, and more preferentially from 0 to 56%, and even more preferentially from 0 to 48%, and even from 10 to 48% and more particularly from 10 to 36, and 10 to 25% by weight of sugars in relation to the total weight of the food composition.

In the meaning of this application, the term “sugars”, plural, designate the mono- and di-saccharides brought alone or through ingredients containing them.

In an advantageous form of embodiment, food compositions according to the invention having a water activity (Aw) greater than 0.93, have a sucrose content from 0 to 20%, preferably from 0 to 15%, and even more preferentially from 0 to 10% by weight in relation to the total weight of the food composition.

One can also consider food compositions according to the invention that are completely without sucrose, a sweet flavor capable to be brought in by fructose and/or sweeteners such as polyols, intense sugar substitutes (e.g. aspartame or acésulfameK), or their mixture.

The food compositions according to the invention may include in addition, among others, emulsifiers, salt, aromas, preservatives, cocoa under different forms (preferably as degreased or greatly degreased cocoa powder), fruits, whole or in chunks, fruits or vegetable mashes, in chunk or in powder, fruit slurry, jams, hazelnuts, or other ground dry fruits, cereals, spices, herbs, soluble or insoluble food fibers, yeasts, or their extracts.

Emulsifiers are those usually used in the domain of the food compositions, namely lecithin, ammonium phosphatide, polyglycerol polyricinoleate (PGPR), or mono- and di-glycerides, or their mixtures.

The aromas may be natural or synthetic aromas. Among natural aromas one can mention vanilla, caramel, cinnamon, and among synthetic aromas: vanillin and some fruit imitation aromas, such as strawberry or raspberry.

Native starch brings a certain level of microorganisms, which can damage the quality of the food composition, namely its stability in general. This risk of degradation notably exists weakly in food compositions with a water activity (Aw) from 0.6 to 0.73, more strongly with Aw from 0.74 to 0.89, and very strongly with Aw from 0.90 to 0.99. This risk, well known of the man of the art, depends also of the pH, the temperature, and the duration of conservation. In order to avoid this phenomenon, one can refrigerate the product and/or, according to its life span, either pasteurize or sterilize (i.e. by irradiation) native starch before incorporating it in the food composition, or add a preservative to the food composition. By “preservatives”, one means compounds inhibiting or delaying the proliferation of microorganisms in the composition, in particular yeasts and/or mildews, and/or bacteria. Preservatives to be added to food compositions according to the invention are those usually used in the domain of food compositions, and notably include sorbic acid and its salts (E200 in E203), benzoic acid and its salts (E210 in E219), sulfites and derivatives (E220 in E228), natamycin, nisin, calcium propionate, and their mixtures.

Preferably, one will use a preservative with Aw greater than 0.72, and especially greater than 0.80. An example of a preferred preservative is potassium sorbate.

Particularly preferred food compositions according to the invention are jams with a water activity (Aw) from 0.60 to 0.75, preferably from 0.65 to 0.72. These jams are suited for a conservation of at least one month at a temperature ranging between 15 and 25° C. after opening. Other particularly preferred food compositions according to the invention are jams with water activity (Aw) from 0.75 to 0.96, preferably from 0.78 to 0.93, and even more preferentially from 0.78 to 0.85. Such jams are suited for conservation over several days at a temperature ranging between 15 and 25° C. and/or to a refrigerated conservation after opening. Advantageously, both types of jams have a fat content from 0 to 10%, preferably from 0 to 5%, and even more preferentially from 0 to 2%, and even from 0 to 0.8% by weight in relation to the total weight of jam, include at least one non-gelatinized starch, and have a sugar content from 10 to 72%, preferably from 10 to 55%, advantageously from 12 to 42%, and even more preferentially from 18 to 30% by weight in relation to the total weight of jam. Advantageously, the sucrose content of jams according to the invention is from 8 to 53%, preferably from 12 to 42%, and even more preferentially from 18 to 30% by weight in relation to the total weight of jam.

Preferably, jams according to the invention include from 2 to 40%, preferably from 4 to 40%, and even more preferentially from 10 to 40%, advantageously from 20 to 40%, and even from 30 to 40% by dry weight in relation to the weight of jam.

Others particularly preferred food composition according to the invention are honey or honey specialties having a water activity (Aw) from 0.50 to 0.80, preferably from 0.55 to 0.70, and even more preferentially from 0.50 to 0.63, and even from 0.56 to 0.63, and a fat content from 0 to 10%, preferably from 0 to 5%, and even more preferentially from 0 to 2%, and even from 0 to 0.5% by weight in relation to the total weight of honey or honey specialty, containing at least one non-gelatinized starch and having a sugars content from 10 to 70%, preferably from 20 to 59%, and even more preferentially from 35 to 55%, and even from 35 to 45% by weight in relation to the total weight of honey or honey specialty.

By “honey specialty” one means a food composition according to the invention including at least 30% by weight of honey.

Preferably honeys or honey specialties according to the invention include from 10 to 40%, preferably from 20 to 40%, and even more preferentially from 26 to 35% of starch dry by weight in relation to the total weight of honey or honey specialty.

The addition of 10 to 40% dry starch by weight in relation to the total weight of honey containing starch in a liquid honey entails a change of texture so that said honey is perceived as a creamy to semi crystalline honey. In addition, the taste of such honey is a little less sugary and less burning as compared to a traditional honey.

The food composition according to the invention can be obtained by dispersing starch in a food composition constituted of a traditional continuous aqueous phase.

Starch gelatinization is a phenomenon well known of the man of the art. It is characterized by an important swelling of the starch granules by water absorption and even up to bursting if heating is too intense. The immediately visible consequences are an increased viscosity and the starch “solubilization” in the aqueous mediums whereas some non-gelatinized granules are only dispersed in suspension. Gelatinized starch “solubilization” results in the disappearance of the turbidity linked to the dispersion of the non-gelatinized starch granule.

The gelatinization occurs in presence of water above a certain temperature. It is a fast and straightforward phenomenon, i.e. almost all the granules of a same native starch in the same medium jellify at a temperature T+/−3° C. Such gelatinization is irreversible.

But the gelatinization temperature of native starch varies according to the nature of the starch, and the composition of the aqueous food medium. Thus, the gelatinization temperature for cassava starch in pure water occurs at 70° C., whatever, e.g., the date of harvest, for potato starch it is at 63° C., for corn starch at 76° C., for wheat starch at 82° C. (measuring method: gelatinization temperature of a 8% starch suspension in water placed in a Brabender viscoamylograph; heating through double envelope at 1.5° C./minute). With regard to the influence of the gelatinization medium composition, the increase in sugar content as well as water reduction increases the gelatinization temperature.

Thus, in the context of this invention, the gelatinization temperature to take into consideration corresponds to the gelatinization temperature of native starch used in the aqueous food medium, and not in pure water.

Thus, in order to preserve the starch in its native state in the food composition according to the invention, it is imperative not to heat it over its gelatinization temperature during the food composition preparation and/or during ulterior use. Preferably, at the time of its preparation and/or subsequently, the food composition according to the invention is heated to a maximum temperature which is 7° C. inferior to the gelling temperature of the starch used. In case a mixture of various starches is used, the lowest gelatinization temperature is determining.

For example, in case of a jam according to the invention, the starch or the starch mixture is added after cooling of the fruit preparation.

It is also possible to do the mixture immediately or shortly before consuming the food composition according to the invention.

Thus, another object of the invention is a kit for preparing a food composition according to the invention as describes previously. Such kit consists of a first package containing a food composition having a continuous aqueous phase, and a second package containing at least one non-gelatinized starch. Advantageously, the second package contains in addition a taste masking agent to conceal the taste of starch. Preferably, the taste masking agent is chosen in the group including sucrose, fructose, freeze-dried fruits, chocolate, cocoa, caramel, pastes to spread . . . , and their mixtures. Such masking agent can be under form of powder or fluid. Preferably, the Aw of the second package is lower or equal to 0.8, preferably, lower or equal to 0.7, and advantageously lower or equal to 0.6.

Preferably, the food composition contained in the first package is a compote or a fruit and/or vegetable mash.

The kit for preparing a food composition according to the invention has the advantage that the native starch is added immediately or shortly before consuming the product. In this way, the risk of degradation of the final product by microorganisms brought by the starch, namely native, is minimized.

The food compositions according to the invention are particularly useful as fillings or toppings for cooked cereal products. The term “cooked cereal products” as used in this application includes dry cookies, wafers, toasts, cereal bars, soft cakes and pastries.

Another object of this invention is therefore a cooked cereal product including a filling or a topping comprising the food composition according to the invention.

The cooked cereal product according to the invention can be, e.g., a dry cookie including at least one layer of filling containing the food composition according to the invention between two layers of dry cookie or wafer. The food composition according to the invention is preferably a jam.

It can also be a filled wafer, in which at least two sheets of wafer are separated by one layer of filling containing the food composition according to the invention. Preferably, the filled wafer includes 2 to 4 sheets of wafers separated one from the other by a layer of filling containing the food composition according to the invention. The food composition according to the invention is preferably a jam.

The cooked cereal product according to the invention can be also a soft cake including a filling containing a food composition according to the invention. The food composition according to the invention is preferably a jam or a honey specialty. The soft cake may include for example a filling core, which can be introduced e.g. by injection. The soft cake can be also a rolled cake obtained by spreading the filling over at least one of the surfaces of the soft cake and then rolling it. The soft cake can also include at least one layer of filling according to the invention between at least two layers of soft cake. The soft cake can also include at least one layer of filling according to the invention between a layer of soft cake and a chocolate or imitation chocolate shell.

Finally, the cooked cereal product according to the invention can also consist of a filling including the food composition according to the invention dropped in a hollow biscuit, for example a tart or a barquette. The food composition according to the invention is preferably a jam.

Generally, the cooked cereal product according to the invention includes from 16% to 55%, advantageously from 20% to 45%, preferably from 25% to 35%, and even more preferentially from 25% to 30% for an additional organoleptic advantage or either from 28 to 35% for an additional organoleptic advantage, by weight of filling including the food composition according to the invention in relation to the total weight of the product finished.

The cooked cereal product according to the invention advantageously contains from 1.5% to 25% by weight of fat in relation to the total weight of the cooked cereal product, preferably from 2 to 15%, of even more preferably from 2 to 10%, and even from 2 to 6%.

The cooked cereal product according to the invention advantageously contains from 20% to 63% by weight of sugars in relation to the total weight of the cooked cereal product, preferably from 27 to 58%, of even more preferably from 27 to 48%, and even from 35 to 46%. Even more preferentially, it includes from 18% to 48% by weight of sugars in relation to the total weight of the cereal cooking product, preferably from 18 to 38%, even more preferably from 18 to 28%, and even from 20 to 25%.

After hermetic packaging, the cooked cereal products according to the invention keep at a temperature from 15 to 25° C. for at least one month, preferably for at least 6 months, if the filling Aw is from 0.3 to 0.6. If Aw is from 0.6 to 0.8, the cooked cereal products according to the invention keep, after hermetic packaging, at a temperature from 15 to 25° C. for at least one week, preferably for at least 1 month. And if the filling Aw is from 0.8 to 0.99, the cooked cereal products according to the invention are suitable notably, after hermetic packaging, for storage at a temperature between 1 and 10° C. for at least 1 week, preferably for at least 1 month, or for storage frozen for at least 1 month, preferably for at least 6 months.

The following examples of embodiment illustrate this invention, without limiting in any way its scope.

### EXAMPLE 1

### Blueberry Jam

### Recipe 1:

A blueberry jam is prepared according to the invention using:
850 g of a blueberry jam having the following composition: saccharose, 50 g of blueberries for 100 g of finished product, pectin, citric acid; total sugar content of 60%
150 g of native rice starch (Remy FG of the Remy Industries company) at 13% of water
1 g of potassium sorbate by mixing all the ingredients at 35° C. in a global Kenwood mixer until obtaining a homogeneous paste, then assaying in 500 g jars, which are closed tightly, then immediately cools.

### Recipe 2:

A blueberry jam is prepared according to the invention following recipe 1 while replacing rice starch by 150 g of native corn starch (Maizena) at 13% of water.

### Recipe 3:

A blueberry jam is prepared according to the invention following recipe 1 while replacing rice starch by 150 g of native wheat starch (Meritena 200, Tate & Lyle)) at 13% of water.

### Evaluation:

The jams of recipes 1, 2, and 3 were compared to a traditional blueberry jam used as reference for their preparation (control). The control was mixed under the same conditions as recipes 1 to 3.

The color of recipes 1, 2, and 3 jams is slightly clarified and opacified in relation to the control. Jam following recipe 1 (native rice starch) presents the most significant clarification.

One also observes an increased viscosity for the jams according to recipes 1, 2, and 3 in relation to control. The jam according to recipe 1 presents the highest viscosity, whereas the jam according to recipe 3 presents the lowest viscosity of the three jams according to the invention, while remaining superior to that of the control.

The jams according to recipes 1, 2, and 3 and control all have a water activity (Aw) af 0.82+/−0.02.

The jams according to recipes 1, 2, and 3 have a slight starch taste and taste slightly less sugary than control, but they are still perceived as traditional jams, as well as the control.

The jams according to recipes 1, 2, and 3 and control have the following nutritional characteristics:

TABLE 1

| | | | | (complex |
|---|---|---|---|---|
| | % | % dry | (total kcal)/ | carbohydrate kcal)/ |
| | sugars * | starch * | 100 g | (total kcal) |
| Recipes | 51 | 13 | 257 | 20.3 |
| 1 to 3 | | | | |
| Control | 60 | 0 | 241 | 0 |

*The percentages are expressed by weight over total weight of jam

Table 1 shows for recipes 1 to 3 a 6.6% increase of total calorie content for 100 g of jam, but the calorie distribution is much better balanced, because 20.3% of the calories come from starch, i.e. from complex, slowly digestible carbohydrates, against 0 for control. Finally, the sugar content was 15% reduced.

### EXAMPLE 2

### Soft Cake Filled with Jam

21 g soft cakes were cooked according to a standard process. Such soft cakes, known of the man of the art, consist by weight of 13% fat, 61.8% carbohydrates of which 22.4% sugars (mono- and di-saccharides, including 17% of sucrose), 6.3% proteins and 16.5% water.

With such soft cakes, one prepares 2 batches of filled soft cakes, corresponding to classic soft cakes filled with jam, of which a batch of control soft cakes containing control jam from example 1, and a soft cake batch according to the invention containing jam according to recipe 3 of example 1.

Immediately after being cooked, the soft cakes are covered with 9 g of the respective jams (or 30% filling and 70% soft cake) using a two needle injection system. Jam is injected at a temperature ranging from 28 to 35° C. The cakes so filled are cooled down to 20° C.

The soft cakes covered according to the invention have an aspect strictly identical to the control, the taste of cake and its silky texture being unaltered. The cakes according to the invention are perceived as very close of the control in terms of odor, sweetness, filling texture (jam). The sugar bonbon, particle-size distribution, and pasty are very close and have not been perceived as significantly different by a panel of consumers.

After hermetic packaging, the soft cakes filled according to the invention keep for at least 1 month at 6° C.

### EXAMPLE 3

### Honey

Recipe 1:

Honey is prepared according to the invention from
700 g of liquid honey (Honey from the Pyrenees), and
300 g of native wheat starch (Meritena 200, Feel & Lyle) at 13% of water

by mixing all the ingredients at 35° C. in a global Kenwood mixer until obtaining a homogeneous paste, then assay in pots of 500 g, which are closed tightly then immediately cools.

Recipe 2:

Honey is prepared according to the invention following recipe 1, using 600 g of liquid honey (honey from the Pyrenees), and 400 g of wheat starch (Meritena 200. Tate & Lyle)) at 13% of water.

### Evaluation:

The honeys of recipes 1 and 2 were compared to traditional honey used as basis for their preparation (control).

The color of recipes 1, 2, and 3 honeys is clarified and opacified in relation to the control. The honey from recipe 2 presents the most important clarification and opacification.

One also observes a great increase in viscosity for the honeys following recipes 1, 2, and 3 as compared to control. The honey according to recipe 2 presents the highest viscosity.

Honeys according to recipes 1, 2, and 3, and control all have a water activity (Aw) of 0.59+/−0.02.

Honeys from recipes 1 and 2 have a distinctly less sugary taste than control, but they are still identified as normal honeys by ten of the ten consumers who tested the honeys according recipes 1 and 2 and control. Eight of these ten consumers preferred the honey according to recipe 2 rather than the control in tasting alone and on white bread baguette.

The honeys according to recipes 1 and 2 are perceived by consumers as traditional semi-crystallized honeys, while the control is perceived as a traditional liquid honey.

Honeys according to recipes 1, 2 and control have the following nutritional characteristics:

TABLE 2

| | | | | (kcal of |
|---|---|---|---|---|
| | % | % dry | (total kcal)/ | total complex |
| | sugars * | starch * | 100 g | carbohydrates)/(kcal) |
| Recipe 1 | 54.2 | 26.1 | 323 | 32.3 |
| Recipe 2 | 46.5 | 34.8 | 326 | 42.7 |
| Control | 77.5 | 0 | 312 | 0 |

Percentages are expressed by weight over total weight of honey

Table 2 shows for recipes 1 and 2 a 3.5 to 4.5% increase in total calorie content for 100 g of jam, respectively, but the calorie distribution is much better balanced, because 32.3 and 42.7% of the calories come from starch, i.e. from complex, slowly digestible carbohydrates, against 0 for control.
Finally, the sugar content is lowered by 30% for recipe 1, and by 40% for recipe 2 as compared to control.

1. A food composition comprising a continuous aqueous phase, said food composition having a water activity (Aw) of 0.3 to 0.99, and a fat content of less than 15% by weight relative to the total weight of the food composition, and comprising at least one non-gelatinized starch.

2. The food composition according to claim 1, wherein the starch is a native starch.

3. The food composition according to claim 1 wherein the food composition is selected from the group consisting of jams, honeys, compotes, fruit mash, and fruit desserts.

4. The food composition according to claim 1, wherein the food composition has an Aw from 0.4 to 0.99.

5. The food composition according to claim 1, wherein dry matter content is less than 80% by weight.

6. The food composition according to claim 1, wherein non-gelatinized starch content is from 2 to 40% by dry weight in relation to the total weight of the food composition.

7. The food composition according to claim 1, wherein the non-gelatinized starch including starch particles and at least 90% of the non-gelatinized starch particles have a particle-size distribution ranging between 2 μM and 100 μM.

8. The food composition according to claim 7, wherein at least 5% of the non-gelatinized starch particles have a size greater than or equal to 10 μm.

9. The food composition according to claim 1, wherein said starch is selected from the group consisting of wheat starch, rice starch, corn starch, waxy corn starch, sorghum starch, tapioca starch, potato starch, cassava starch, and their mixtures.

10. The food composition according to claim 1, where the fat content is from 0 to 10% by weight in relation to the total weight of the food composition.

11. The food composition according to claim 1, wherein the food composition has a sugar content of from 0 to 84% by weight in relation to the total weight of the food composition.

12. The food composition according to claim 1, wherein the Aw is greater than or equal to 0.93, and the food composition has a sucrose content from 0 to 20% by weight in relation to the weight.

13. (canceled)

14. A kit for preparing a food composition comprising a first package containing a food composition, and a second package containing at least one non-gelatinized starch.

15. A kit according to claim 14, wherein the second package contains a taste masking agent.

16. A cooked cereal product comprising a filling, the filling comprising a food composition according to claim 1.

17. The cooked cereal product according to claim 16, wherein the cooked cereal product comprises dry biscuit including at least one layer of said filling between two layers of dry biscuit or wafer.

18. The cooked cereal product according to claim 16, wherein the filling is dropped in a hollow biscuit or a chocolate shell.

19. The cooked cereal product according to claim 16, wherein the cooked cereal product is a soft cake.

20. The cooked cereal product according to claim 19, wherein the cooked cereal product includes a soft cake comprising a filling core.

21. The cooked cereal product according to claim 19, wherein the cooked cereal product includes a rolled soft cake obtained by spreading the filling over at least one of the surface of said soft cake, and then rolling it.

22. The cooked cereal product according to claim 19, wherein the cooked cereal product includes a soft cake including at least one layer of said filling between at least two layers of soft cake.

23. The cooked cereal product according to claim 19, wherein the cooked cereal product includes a soft cake including at least one layer of said filling between one layer of soft cake and a chocolate or imitation chocolate shell.

24. The cooked cereal product according to claim 16, wherein the cooked cereal product includes from 16% to 55% by weight of filling containing the food composition in relation to a total weight of a product finished.

25. The cooked cereal product according to claim 16, wherein the cooked cereal product includes from 1.5% to 25% by weight of fat in relation to the total weight of the finished cooked cereal product.

26. The cooked cereal product according to claim 16, wherein the cooked cereal product includes from 20% to 63% by weight of sugar in relation to the total weight of the finished cooked cereal product.
